(19) United States
(12) Patent Application Publication
(10) Pub. No.: US 2026/0029013 A1
(43) Pub. Date: Jan. 29, 2026

(54) NUT FOR HEAT SINK AND HEAT SINK ASSEMBLY INCLUDING THE SAME

(71) Applicant: ILLINOIS TOOL WORKS INC., Glenview, IL (US)

(72) Inventor: Ming Cheng LIN, Kaohsiung (TW)

(21) Appl. No.: 19/277,061

(22) Filed: Jul. 22, 2025

(30) Foreign Application Priority Data
Jul. 23, 2024 (TW) 113207915

(51) Int. Cl. F16B 37/04; G06F 1/20

(52) U.S. Cl. CPC F16B 37/04; G06F 1/20

(57) ABSTRACT

The present application relates to a nut for a heat sink, including: a plastic hollow body having an inner surface disposed with an internal thread thereon, wherein one end of the plastic hollow body has: at least one buckle feature disposed on an outer surface of the plastic hollow body for engaging with the heat sink; and a head located at the other end of the plastic hollow body and having an outer diameter larger than an outer diameter of the plastic hollow body.

### FIELD OF THE DISCLOSURE

The present application generally relates to a nut, and particularly to a nut used for a heat sink and a heat sink assembly including the same.

### BACKGROUND

FIGS. 1A-1C show flowcharts of assembling a CPU 16 and a heat sink 18 onto a mainboard 10. FIG. 1A shows a top view of the mainboard 10 with no CPU 16 and heat sink 18 installed thereon yet. FIG. 1B shows a top view of the mainboard with the CPU 16 installed but no heat sink 18 installed thereon yet. FIG. 1C shows a top view of the mainboard with the CPU 16 and the heat sink 18 both installed thereon. Referring to FIG. 1A, the currently available mainboard 10 has a CPU slot 12 provided on the mainboard 10 and a back plate 50 (see FIG. 7A) provided on the back side of the mainboard 10, which is fixed to the back side of the mainboard 10 by fasteners 14. After purchasing the mainboard 10, if a user intends to install the CPU 16 into the CPU slot 12, the fasteners 14 of the back plate 50 are required to be removed from the mainboard 10 in the first place, and then the CPU 16 can be installed into the CPU slot (see FIG. 1B). Next, referring to FIG. 1C, the user needs to engage the heat sink 18, by passing screws 20 (see FIG. 2) through the mainboard 10, with nuts 52 (see FIG. 7A) on the back plate 50, thereby completing the assembly.

FIG. 2 shows a side view of a conventional heat sink assembly. In FIG. 1C, when installing the heat sink 18 onto the mainboard 10, the screws 20 are required to pass through loading springs 22, upper gaskets 24, holders 26, and lower gaskets 24 in sequence before they can further pass through the mainboard 10 to engage with the nuts 52 (see FIG. 7A) on the back plate 50. This is not only cumbersome in assembly but also requires more elements to fulfill the installation of the heat sink 18. Additionally, the conventional screws 20 and nuts 52 (see FIG. 7A) are both made of metal which might, after repeated assembly for many times, produce metal debris between the two during assembly due to material fatigue. The fallen metal debris will inevitably come into contact with various electronic devices and/or metal contacts on the mainboard 10, resulting in a short circuit and ultimately burning down the entire mainboard.

Therefore, there is a need in the art for a nut used for a heat sink, as well as a heat sink assembly, which facilitate assembly, save materials, and avoid damage to the mainboard.

### SUMMARY

According to an aspect of the present disclosure, a nut for a heat sink is provided, including: a plastic hollow body having an inner surface disposed with an internal thread thereon, wherein one end of the plastic hollow body has: at least one buckle feature disposed on an outer surface of the plastic hollow body for engaging with the heat sink; and a head located at the other end of the plastic hollow body and having an outer diameter larger than an outer diameter of the plastic hollow body.

According to another aspect of the present disclosure, a heat sink assembly is provided, comprising: a heat sink, having at least two holders symmetrically disposed on a periphery thereof; at least two nuts as described above passing through the at least two holders, respectively, wherein at least one buckle feature of each of the at least two nuts buckles against the lower surface of each of the at least two holders, upon passing through each of the at least two holders; at least two loading springs, each disposed between the head of one of the at least two nuts and an upper surface of one of the at least two holders, respectively, wherein two ends of each of the at least two loading springs abut against the head of one of the at least two nuts and the upper surface of one of the at least two holders, respectively; and a back plate, having at least two screws disposed on the back plate at positions corresponding to the at least two holders, wherein each of the at least two screws has an external thread that mates with an internal thread of each of the at least two nuts, and wherein the heat sink is connected to the at least two nuts and the back plate by the internal threads of the at least two nuts and the external threads of the at least two screws of the back plate.

In some examples, the nut further includes: at least one open slot, disposed at the end of the plastic hollow body, penetrating from the outer surface of the plastic hollow body to the inner surface of the plastic hollow body.

In some examples, the at least one open slot is two open slots spaced apart from each other by a spacing.

In some examples, the spacing does not exceed half of a circumference of the plastic hollow body.

In some examples, the at least one buckle feature is a protrusion.

In some examples, the protrusion has a gradually increasing surface and a radially extending surface, wherein the gradually increasing surface increases from the end toward the other end of the plastic hollow body gradually and intersects with the radially extending surface that extends radially from the outer surface of the plastic hollow body.

In some examples, the at least one buckle feature is at least three buckle features.

In some examples, the at least one buckle feature is disposed between the two open slots.

In some examples, the at least two holders are four holders symmetrically disposed around a periphery of the heat sink, the at least two nuts are four nuts, and the at least two screws are four screws.

In some examples, each of the at least two holders is C-shaped.

### BRIEF DESCRIPTION OF THE DRAWINGS

So that the aforementioned features of the present disclosure can be understood in detail, reference may be made to embodiments for a more specific description of the present disclosure briefly summarized above, some of which are illustrated in the accompanying drawings. However, it should be noted that the accompanying drawings only illustrate exemplary embodiments of the present disclosure and therefore should not be construed as limiting its scope, as the present disclosure may admit to other equivalent embodiments.

FIGS. 1A-1C show flowcharts of assembling a CPU and a heat sink onto a mainboard, wherein FIG. 1A shows a top view of the mainboard with no CPU and heat sink installed thereon yet, FIG. 1B shows a top view of the mainboard with the CPU installed but no heat sink installed thereon yet, and FIG. 1C shows a top view of the mainboard with the CPU and the heat sink both installed thereon.

FIG. 2 shows a side view of a conventional heat sink assembly.

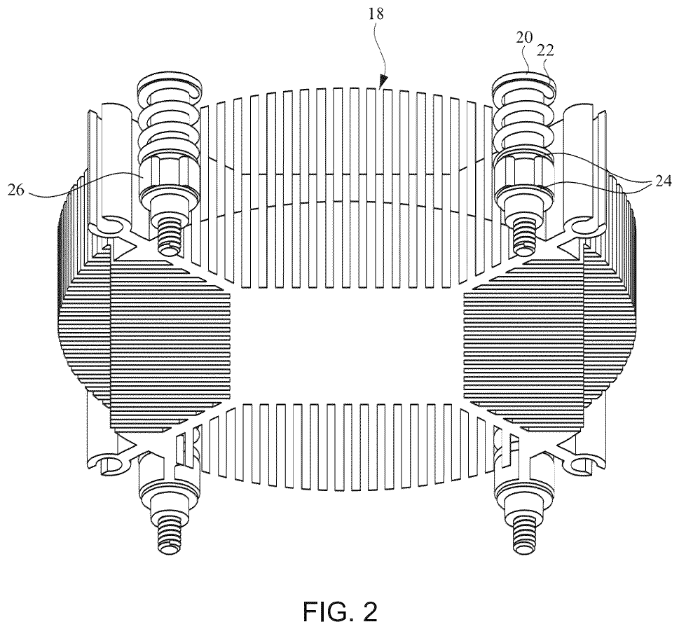

FIG. 3 shows a perspective view of a nut according to some examples of the present application.

FIG. 4 shows a side view of the nut according to some examples of the present application.

FIG. 5 shows a perspective view of the nut installed on the heat sink according to some examples of the present application.

FIG. 6 shows a side view of the nut with a liner on its inner surface according to some examples of the present application.

FIG. 7A shows a schematic diagram of a conventional heat sink assembly.

FIG. 7B shows a schematic diagram of a heat sink assembly according to some examples of the present application.

For case of understanding, identical reference numerals are used to designate identical elements common to the drawings where possible. It is contemplated that elements and features of one embodiment may be advantageously incorporated into other embodiments without further recitation.

### DETAILED DESCRIPTION

The present application provides a nut for a heat sink, including: a plastic hollow body having an inner surface disposed with an internal thread thereon, wherein one end of the plastic hollow body has: at least one buckle feature disposed on an outer surface of the plastic hollow body for engaging with the heat sink; and a head located at the other end of the plastic hollow body and having an outer diameter larger than an outer diameter of the plastic hollow body.

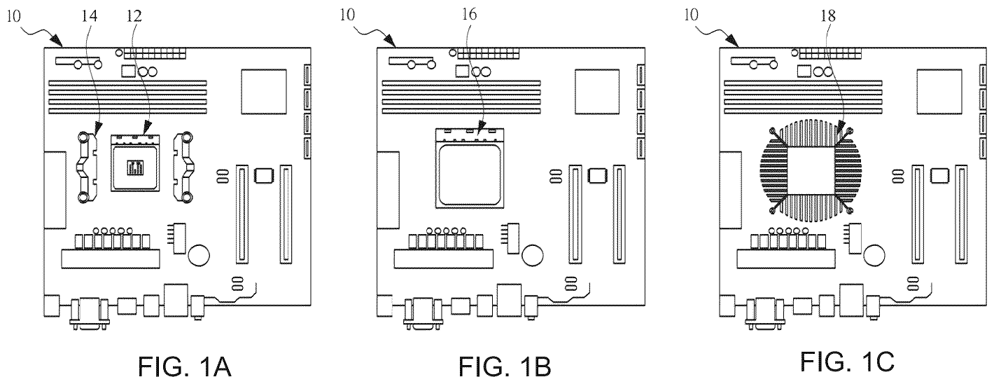

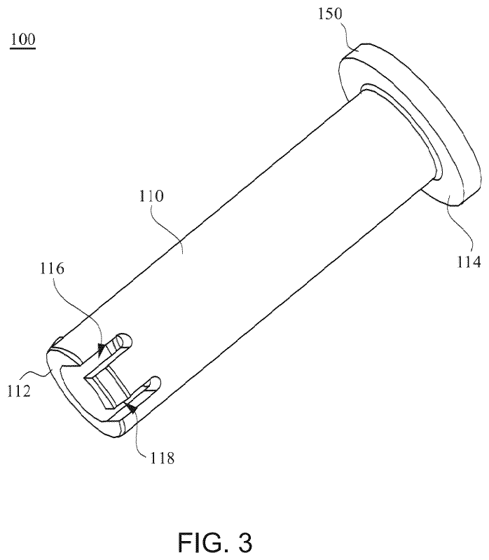

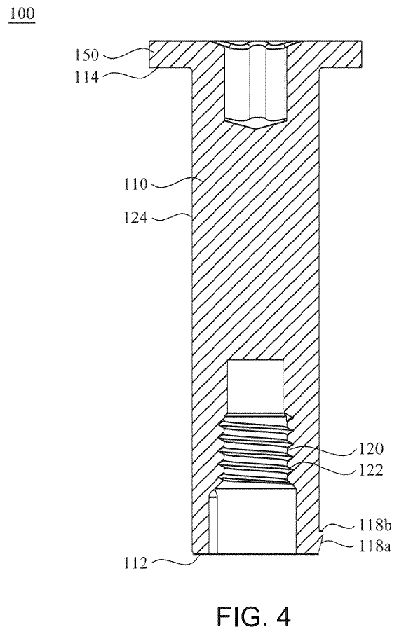

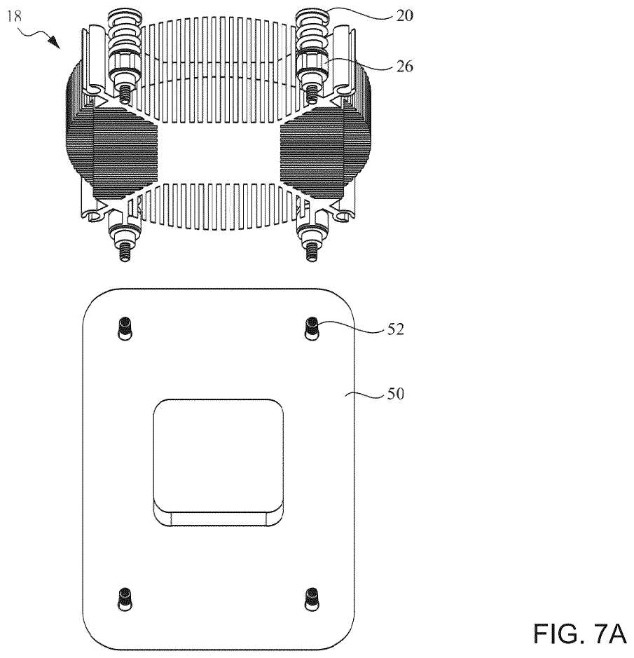

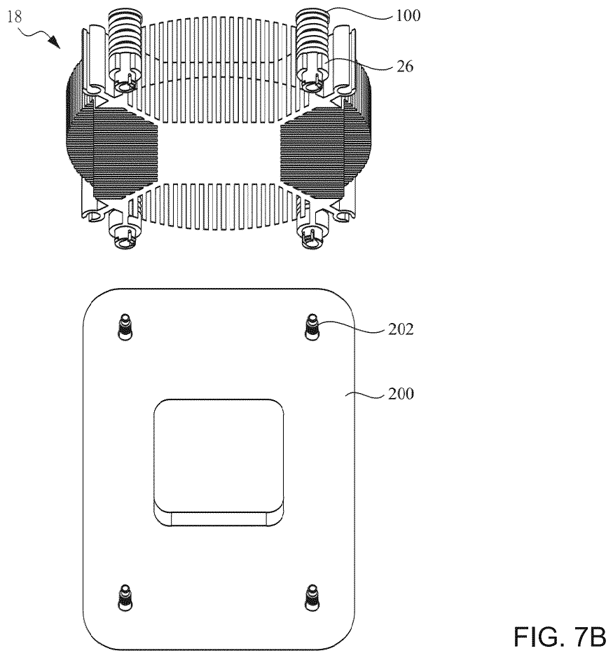

FIG. 3 shows a perspective view of a nut according to some embodiments of the present application. FIG. 4 shows a side view of the nut according to some embodiments of the present application. Technical features of a nut 100 of the present application will be described below with reference to FIGS. 3 and 4. The nut 100 of the present application can be used with the commercially available heat sink 18 (see FIG. 1C) without further modification to the structure of the commercially available heat sink 18, thereby widening its scope of application. The nut 100 includes a plastic hollow body 110 and a head 150. An inner surface 120 of the plastic hollow body 110 may be provided with an internal thread 122 thereon for engaging with an external thread of a screw 202 on a back plate 200 of the present application (see FIG. 7B), thereby connecting the heat sink 18 onto the mainboard 10.

The plastic hollow body 110 has two ends 112 and 114. At one end 112 of the plastic hollow body 110, there may be at least one buckle feature 118. The buckle feature 118 may be disposed on an outer surface 124 of the plastic hollow body 110 for buckling together with the heat sink 18. The buckle feature 118 may be either a continuous buckle feature 118 surrounding the entire end 112 or a plurality of spaced-apart buckle features 118. Thus, the number of buckle features 118 may be one, two, three, or more. When the number of buckle features 118 is plural, the plurality of buckle features 118 may be either symmetrically disposed or asymmetrically disposed. In some embodiments of the present application, the buckle feature 118 is a protrusion. In some embodiments of the present application, the protrusion may have a gradually increasing surface 118a and a radially extending surface 118b. The gradually increasing surface 118a increases gradually from the end 112 toward the other end 114 of the plastic hollow body 110, and intersects with the radially extending surface 118b extending radially from the outer surface 124 of the plastic hollow body 110, thereby forming the protrusion disposed on the outer surface 124 of the plastic hollow body 110.

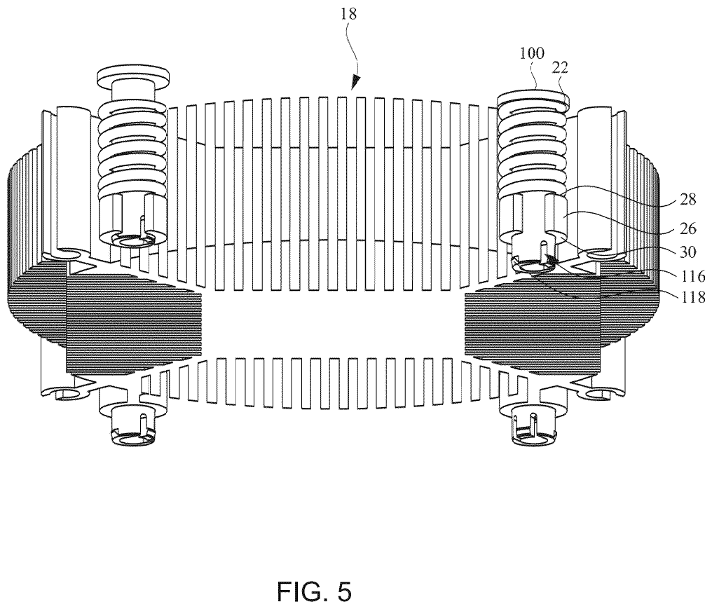

The head 150 is located at the other end 114 of the plastic hollow body 110, and has and outer diameter greater than that of the plastic hollow body 110, thereby allowing the head 150 to abut against the loading spring 22 after the plastic hollow body 110 of the nut 100 passes through the loading spring 22, thus retaining the loading spring 22 in place (see FIG. 5).

FIG. 5 shows a perspective view of the nut installed on the heat sink according to some embodiments of the present application. The heat sink 18 is typically provided with the symmetrical holders 26 around its periphery for installing the heat sink 18 onto the mainboard 10. Although the embodiment in FIG. 5 shows four holders 26, the number of holders 26 is not limited thereto, as long as the heat sink 18 is properly installed and secured. To assemble the nut 100 and the heat sink 18, the nut 100 is passed through the loading spring 22 and then through the holder 26. The loading spring 22 is located between the head 150 of the nut 100 and a upper surface 28 of the holder 26, with both ends of the loading spring 22 abutting against the head 150 of the nut 100 and the upper surface 28 of the holder 26, respectively. A first position is shown for the left nut 100 where the nut 100 passes through the holder 26. In the first position, due to the elasticity of the plastic hollow body 110, the buckle feature 118 on the end 112 may be compressed inward to pass through an aperture of the holder 26. A second position is shown for the right nut 100 where the nut 100 passes through the holder 26. In the second position, after the end 112 of the nut 100 passes through the aperture of the holder 26, due to an clastic restoring force, the end 112 restores its original radius, and the elastic force of the loading spring 22 causes the buckle feature 118 of the nut 100 to buckle against a lower surface 30 of the holder 26, thereby securing the nut 100 within the holder 26 and completing the assembly of the nut 100 and the heat sink 18.

Referring back to FIG. 3, in some examples of the present application, the end 112 of the nut 100 may further include at least one open slot 116. The open slot 116 passes through the outer surface 124 of the plastic hollow body 110 until the inner surface 120 of the plastic hollow body 110. The open slot 116 allows easier inward compression of the plastic hollow body 110, facilitating the passage of the buckle feature 118 disposed at the end 112 through the aperture of the holder 26 when installing the nut 100 through the holder 26 of the heat sink 18. As shown in FIG. 3, in some embodiments of the present application, the open slot 116 may be two open slots 116 spaced apart by a spacing. In some examples of the present application, the spacing does not exceed half of a circumference of the plastic hollow body 110. In some examples of the present application, the buckle feature 118 may be disposed between the two open slots 116.

In some examples of the present application, in addition to the plastic hollow body 110, the head 150 may also be made of plastic. When both the hollow body 110 and the head 150 are made of plastic, the nut 100 may be integrally formed.

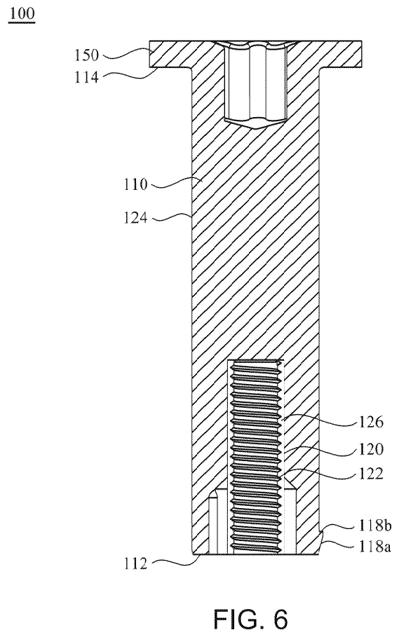

FIG. 6 shows a side view of the nut with a liner on its inner surface according to some embodiments of the present application. In some embodiments of the present application, only a portion of the nut 100 that engages with the metal screw 202 (see FIG. 7B) is made of plastic. Therefore, in some embodiments of the present application, the nut 100 may be made of metal, with a plastic liner 126 lined inside the hollow body 110. The liner 126 may have the internal thread 122 inside for engaging with the screw 202 of the back plate 200. In this embodiment, since the liner 126 on the inner surface 120 of the nut 100 is made of plastic, after repeated assembly for many times, only plastic debris is produced when the screw 202 is screwed into the nut 100 (see FIG. 7B), without causing short circuit in electronic devices and/or metal contacts on the mainboard 10.

FIG. 7A shows a schematic diagram of a conventional heat sink assembly. After installing the screw 20 to the holder of the heat sink 18, the nut 52 riveted to the back plate 50 is further engaged with the screw 20 to complete the assembly of the heat sink assembly and the mainboard 10. As aforementioned, since metal debris may be produced when the metal screw 20 is screwed into the metal nut 52, it may cause short circuits in the electronic devices and/or metal contacts on the mainboard 10.

FIG. 7B shows a schematic diagram of a heat sink assembly according to some embodiments of the present application. According to some embodiments of the present application, the heat sink assembly may include the heat sink 18, the nut 100, the loading spring 22 (see FIG. 5), and the back plate 200. The back plate 200 has the screw 202 riveted thereon, and the screw 202 is disposed on the back plate 200 at a position corresponding to the holder 26. The screw 202 has an external thread that engages with the internal thread 122 of the nut 100. After the assembly of the nut 100 and the heat sink 18 as shown in FIG. 5, the heat sink 18 is connected together via the internal thread 122 of the nut 100 and the external thread of the screw 202 on the back plate 200, thereby completing the assembly of the heat sink assembly. In the embodiment shown in FIG. 7B, four holders 26 of the heat sink 18, four nuts 100, and four screws 202 are illustrated, without limitation thereto, as long as they correspond to each other in quantity.

Referring back to FIG. 5, in some embodiments of the present application, the holder 26 may be C-shaped, but is not limited thereto. In the case that the holder 26 is C-shaped, it is particularly suitable for embodiments herein of the nut 100 with its hollow body 110 having no open slot 116. When the hollow body 110 without any open slot 116 passes through the holder 26, the C-shaped holder 26 may expand outward to facilitate the passage of the buckle feature 118 of the nut 100, may restore its original aperture after the buckle feature 118 passes through the holder 26, and. In addition, the elastic force of the loading spring 22 causes the buckle feature 118 of the nut 100 to buckle against the lower surface 30 of the holder 26, thereby securing the nut 100 within the holder 26 and completing the assembly of the nut 100 and the heat sink 18.

The nut for the heat sink and the heat sink assembly of the present application are easier to assemble because they utilize buckle features instead of a gasket for fixation. Additionally, since no additional gasket is required to secure both ends of the holder of the heat sink, material costs may also be reduced. Furthermore, debris produced by the plastic hollow body will not cause short circuits in electronic devices and/or metal contacts on the mainboard, thereby preventing damage to the mainboard.

Embodiments described above are for illustrative purposes only and do not limit the scope of the present application. Those skilled in the art can make various modifications and changes to the embodiments of the present application without departing from the scope thereof. The scope of the present application is determined by the following claims.

### DESCRIPTION OF REFERENCE NUMERALS

10 mainboard
12 CPU slot
14 fastener
16 CPU
18 heat sink
20 screw
22 loading spring
24 gasket
26 holder
28 upper surface
30 lower surface
50 back plate
52 nut
100 nut
110 hollow body
112 end
114 end
116 open slot
118 buckle feature
118a gradually increasing surface
118b radially extending surface
120 inner surface
122 internal thread
124 outer surface
126 liner
150 head
200 back plate
202 screw

What is claimed is:

1. A nut for a heat sink, comprising:
a plastic hollow body having an inner surface disposed with an internal thread thereon, wherein one end of the plastic hollow body has:
at least one buckle feature disposed on an outer surface of the plastic hollow body for engaging with the heat sink; and
a head located at the other end of the plastic hollow body, wherein an outer diameter of the head is greater than an outer diameter of the plastic hollow body.

2. The nut of claim 1, further comprising: at least one open slot disposed at the end of the plastic hollow body, and penetrating from the outer surface of the plastic hollow body to the inner surface of the plastic hollow body.

3. The nut of claim 2, wherein the at least one open slot is two open slots spaced apart from each other by a spacing.

4. The nut of claim 3, wherein the spacing does not exceed half of a circumference of the plastic hollow body.

5. The nut of claim 3, wherein the at least one buckle feature is disposed between the two open slots.

6. The nut of claim 1, wherein the at least one buckle feature is a protrusion.

7. The nut of claim 6, wherein the protrusion has a gradually increasing surface and a radially extending surface, and the gradually increasing surface increases from the end toward the other end of the plastic hollow body gradually and intersects with the radially extending surface that extends radially from the outer surface of the plastic hollow body.

8. The nut of claim 1, wherein the at least one buckle feature is at least three buckle features.

9. A heat sink assembly, comprising:
a heat sink having at least two holders symmetrically disposed on a periphery thereof;
at least two nuts passing through the at least two holders, respectively, each of the at least two nuts according to claim 1, wherein the at least one buckle feature of each of the at least two nuts buckles against a lower surface of each of the at least two holders, upon passing through each of the at least two holders;
at least two loading springs, each disposed between the head of each of the at least two nuts and an upper surface of each of the at least two holders, respectively, wherein two ends of each of the at least two loading springs abut against the head of each of the at least two nuts and the upper surface of each of the at least two holders, respectively; and
a back plate having at least two screws disposed on the back plate at positions corresponding to the at least two holders, wherein each of the at least two screws has an external thread mating with the internal thread of each of the at least two nuts, and wherein the heat sink is connected with the at least two nuts and the back plate by the internal threads of the at least two nuts and the external threads of the at least two screws of the back plate.

10. The heat sink assembly of claim 9, wherein the at least two holders are four holders symmetrically disposed around the periphery of the heat sink, the at least two nuts are four nuts, and the at least two screws are four screws.

11. The heat sink assembly of claim 9, wherein each of the at least two holders is C-shaped.
